(19) United States
(12) Patent Application Publication
(10) Pub. No.: US 2014/0197082 A1
(43) Pub. Date: Jul. 17, 2014

(54) FILTRATION ASSEMBLY

(71) Applicant: GRAYL INC., Camano Island, WA (US)

(72) Inventors: Nancie Weston, Camano Island, WA (US); Travis Merrigan, Seattle, WA (US); Michael Bargiel, Phoenix, AZ (US)

(73) Assignee: GRAYL INC., Camano Island, WA (US)

(21) Appl. No.: 14/157,377

(22) Filed: Jan. 16, 2014

Related U.S. Application Data
(60) Provisional application No. 61/753,371, filed on Jan. 16, 2013.

(51) Int. Cl. B01D 35/143

(52) U.S. Cl. CPC B01D 35/143
USPC 210/87; 210/85; 210/91

(57) ABSTRACT

A filtration assembly generally includes a housing having a first end configured to interface with an outer container and having a second end configured to interface with an inner sleeve, wherein the housing includes a plurality of apertures configured to pass a liquid therethrough, and a counting device carried by the housing, wherein the counting device is configured to indicate to a user that an associated filter is exhausted.

### CROSS-REFERENCE TO RELATED APPLICATION

This application claims the benefit of U.S. Provisional Application No. 61/753371, filed Jan. 16, 2013, the disclosure of which is hereby expressly incorporated herein by reference in its entirety.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a filtration assembly is provided. The filtration assembly generally includes a housing having a first end configured to interface with an outer container and having a second end configured to interface with an inner sleeve, wherein the housing includes a plurality of apertures configured to pass a liquid therethrough. The filtration assembly further includes a counting device carried by the housing, wherein the counting device is configured to indicate to a user that an associated filter is exhausted.

In accordance with another embodiment of the present disclosure, a container assembly is provided. The container assembly generally includes an outer container having an open ended cavity configured to hold a quantity of liquid, and an inner sleeve configured to slide within the open ended cavity. The container assembly further includes a filtration assembly including a housing having a first end configured to interface with the outer container and having a second end configured to interface with the inner sleeve, wherein the housing includes a plurality of apertures configured to pass a liquid between the outer container and the inner sleeve, and a counting device carried by the housing, wherein the counting device is configured to indicate to a user that an associated filter is exhausted.

In accordance with another embodiment of the present disclosure, a filtration assembly is provided. The filtration assembly generally includes a filter, and the filtration assembly is configured to indicate to a user that the filter should be replaced.

In accordance with another embodiment of the present disclosure, a counting device for a filtration assembly is provided. The counting device is generally configured to indicate to a user that an associated filter is exhausted.

In accordance with another embodiment of the present disclosure, a filtration system is provided. The filtration assembly is substantially as described herein with reference to any one of the embodiments shown in the drawings.

In accordance with any of the embodiments described herein, the liquid to be filtered may include water.

In accordance with any of the embodiments described herein, the first end of the housing may be configured to interface with an inner cavity of the outer container to provide positive pressure liquid displacement.

In accordance with any of the embodiments described herein, the inner cavity of the outer container and the inner sleeve may be concentric with one another.

In accordance with any of the embodiments described herein, the filtration assembly may further include a filter supported by the housing and disposed in liquid communication with the plurality of apertures and the inner sleeve.

In accordance with any of the embodiments described herein, the filter may become exhausted after a predetermined volume of liquid passes through the filter.

In accordance with any of the embodiments described herein, the filter may be selected from the group consisting of screens, sieve filters, granular-activated carbon filters, metallic alloy filters, microporous ceramic filters, a carbon block resin filters, electrostatic nanofiber filters, reverse osmosis filters, ion exchange filters, UV light filters, hollow fiber membrane filters, and ultra-filtration membrane filters.

In accordance with any of the embodiments described herein, the indication to a user that an associated filter is exhausted may be dependent on volume of filtered liquid.

In accordance with any of the embodiments described herein, the counting device may include a first movable member positioned to interface with the outer container when the housing moves within the inner cavity of the outer container a selected amount; and a second movable member associated with the first movable member and configured to conditionally move along a path of travel having predetermined total distance, wherein the second movable member sequentially moves a fixed segment of the path of travel with respect to the housing each time the housing moves within the inner cavity of the outer container the predetermined amount.

In accordance with any of the embodiments described herein, the counting device may indicate to a user that an associated filter is exhausted when the second movable member has moved along the path of travel a distance substantially equal to the predetermined total distance.

In accordance with any of the embodiments described herein, the first movable member may be biased in a first position, and configured for translational movement between the first position and a second position relative to the outer container.

In accordance with any of the embodiments described herein, the second movable member may be configured for rotational movement to sequentially move a fixed segment of the path of travel with respect to the housing each time the first movable member moves from the first position to the second position.

In accordance with any of the embodiments described herein, the second movable member may be configured for rotational movement to sequentially move a fixed segment of the path of travel with respect to the housing each time the first movable member moves from the second position to the first position.

In accordance with any of the embodiments described herein, the second movable member may contact a portion of the outer container when moved along the path of travel a distance substantially equal to the predetermined total distance.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is an isometric view of a filtration assembly in accordance with one embodiment of the present disclosure;

FIG. 2 is an exploded view of the filtration assembly of FIG. 1;

FIG. 3 is a partially exploded, cross-sectional view of the filtration assembly of FIG. 1;

FIG. 4A is a cross-sectional view of the filtration assembly of FIG. 1 in use in a container assembly in a filtering process;

FIG. 4B is a cross-sectional view of the filtration assembly of FIG. 1 in use in a container assembly after completing the filtration process;

FIGS. 5A-5D are isometric views of the filtration assembly of FIG. 1 in use in a container assembly;

FIGS. 6A-11B are isometric and side views of the filtration assembly of FIG. 1 in a series of process steps to advance the counting assembly of the filtration assembly one count; and

FIGS. 12A-12C includes three side cross-sectional views of the filtration assembly of FIG. 1 in use in three container assemblies of various sizes.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

Embodiments of the present disclosure are generally directed to filtration assemblies having counting and/or disable notification features. Generally, examples of the filtration assembly count a number of uses and alert the user that replacement is desired after the specified number of uses have been met.

One or more filtration assemblies illustrated in the FIGURES have been designed for use in a positive pressure filtration container assembly, for example, as described in U.S. Patent Publication No. 20140008310, published on Jan. 9, 2014. However, it should be appreciated that the filtration assemblies of the present disclosure may also be used in other types of filtration systems. In some embodiments, the filtration assembly may include a feature that disables use after counting a predetermined number of uses.

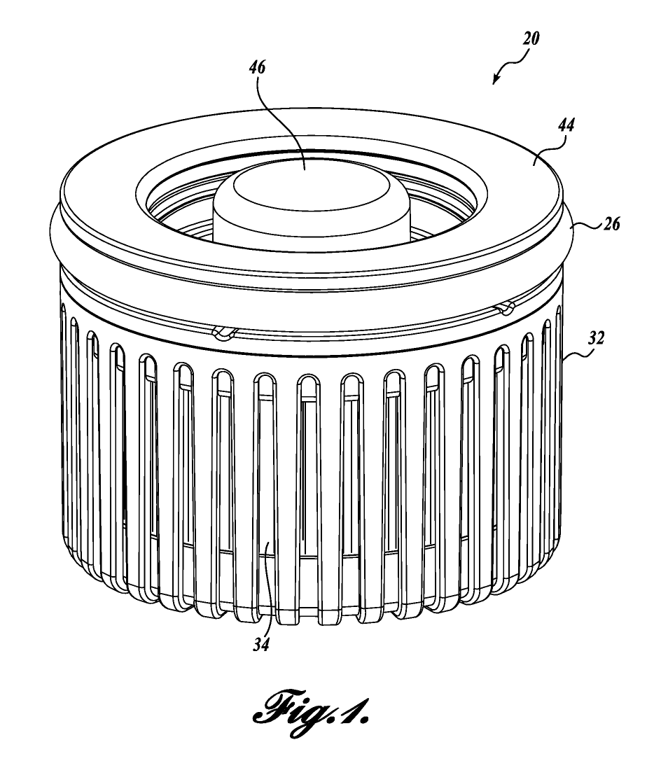

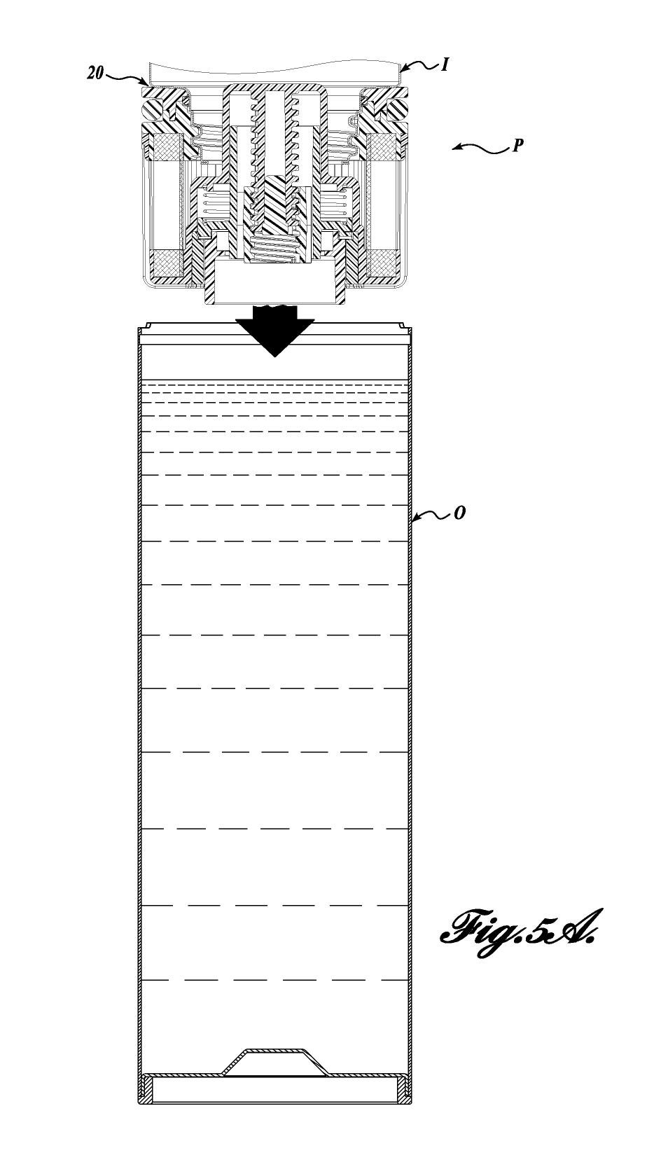

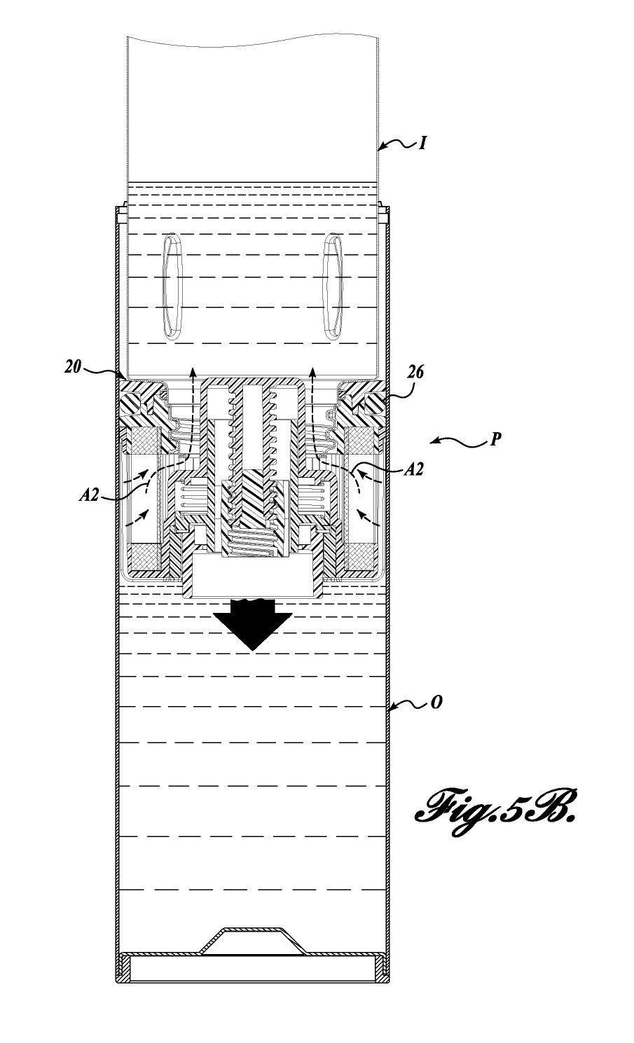

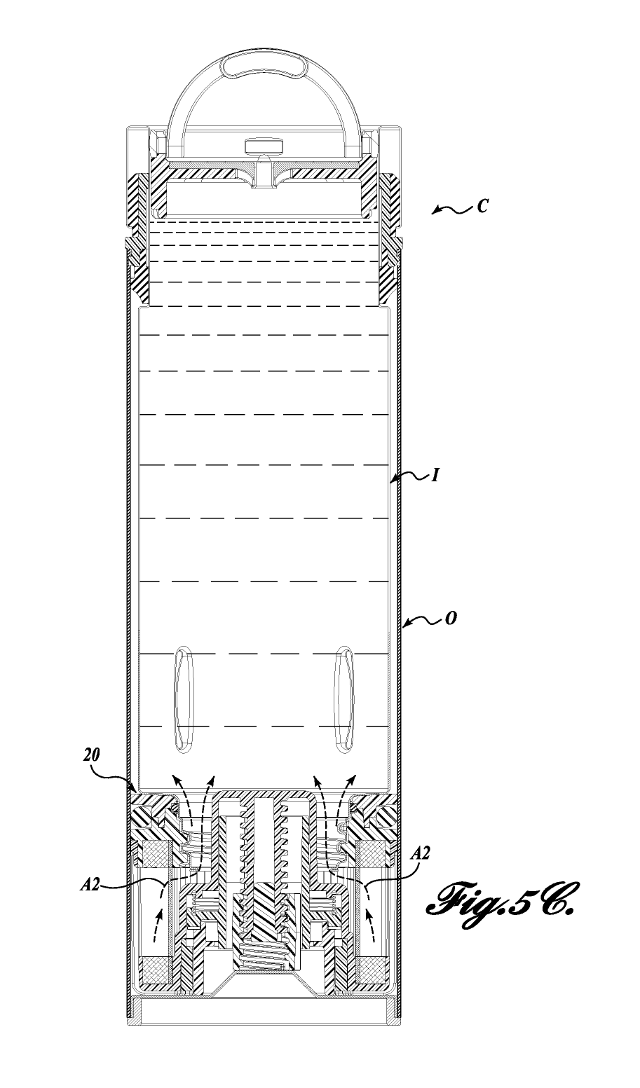

Referring now to FIGS. 1-4B, there is shown one example of a filtration assembly, generally designed 20, in accordance with aspects of the present disclosure. As best shown in FIGS. 1-4B, the filtration assembly 20 includes a filter housing, filter media 24, and first and second seals 26 and 28 for interfacing with a container assembly C (see FIGS. 5C and 5D). The filtration assembly 20 further includes a counting assembly 60, as will be described in greater detail below. It should be appreciated that the filtration assembly 20 may be removable and replaceable within the container assembly C for a new or different filter.

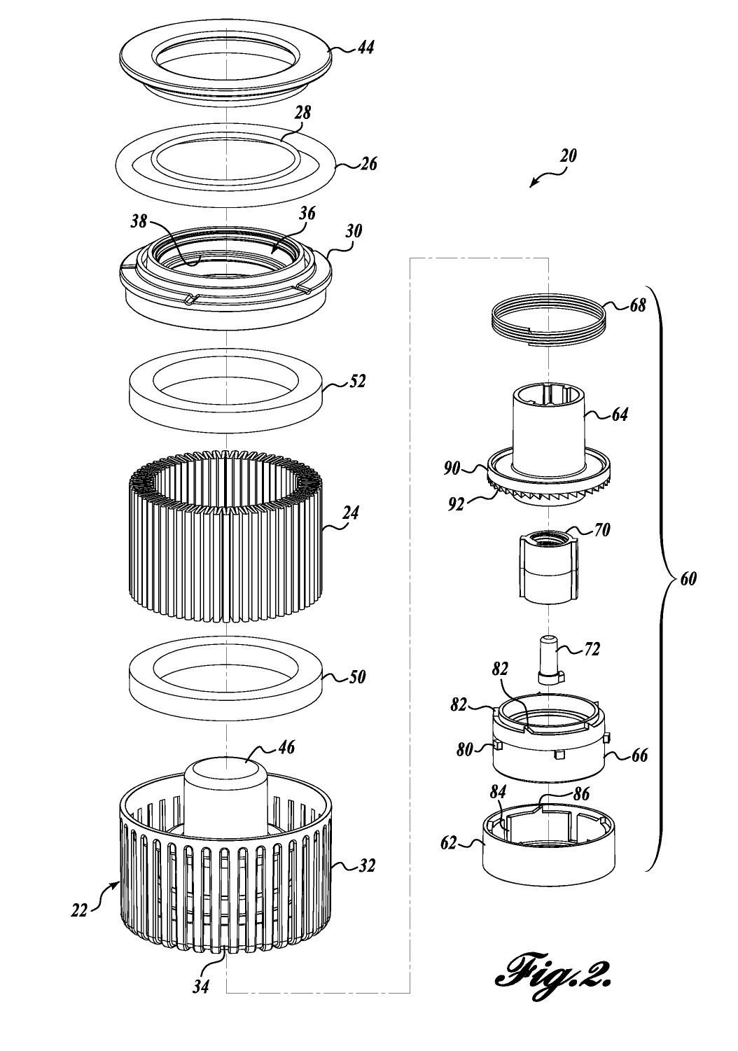

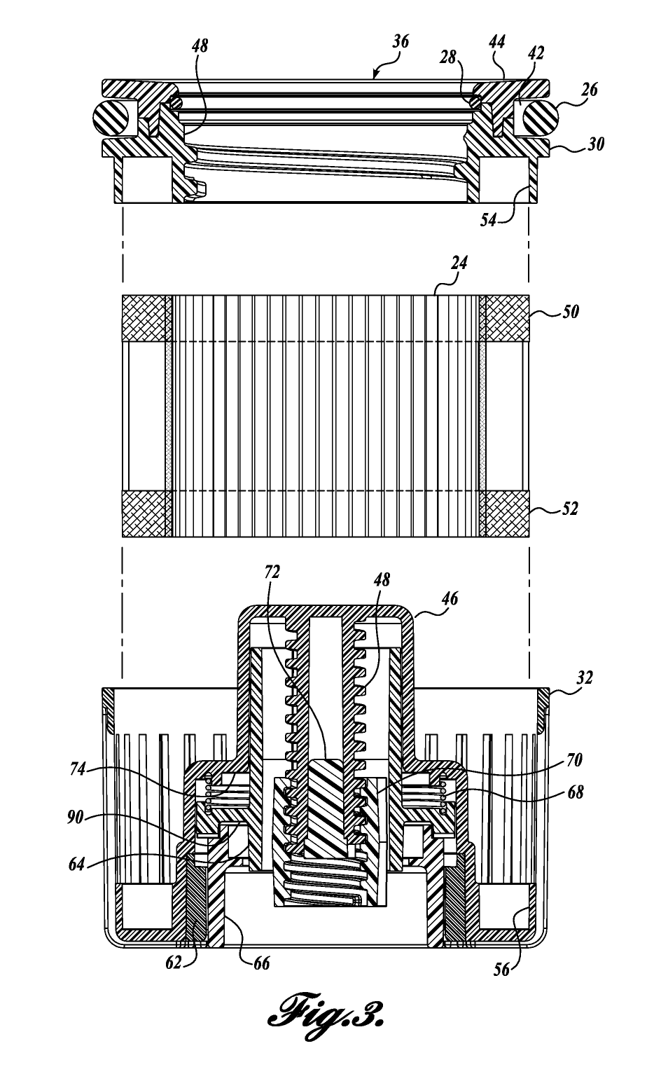

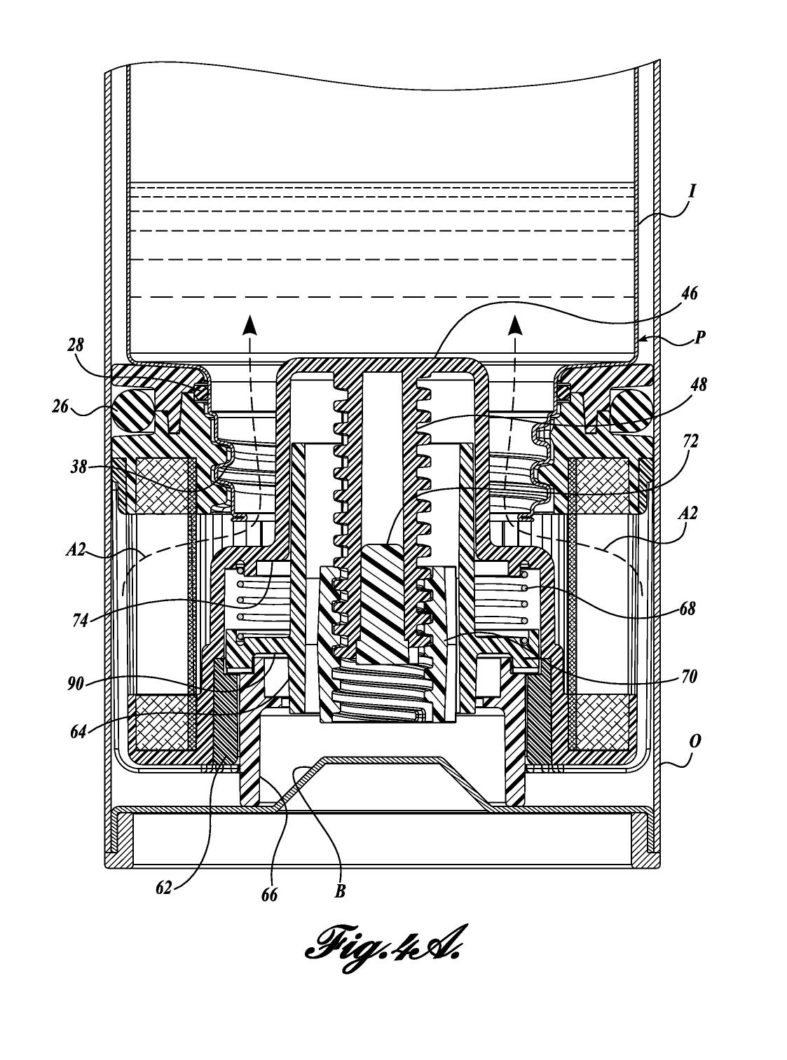

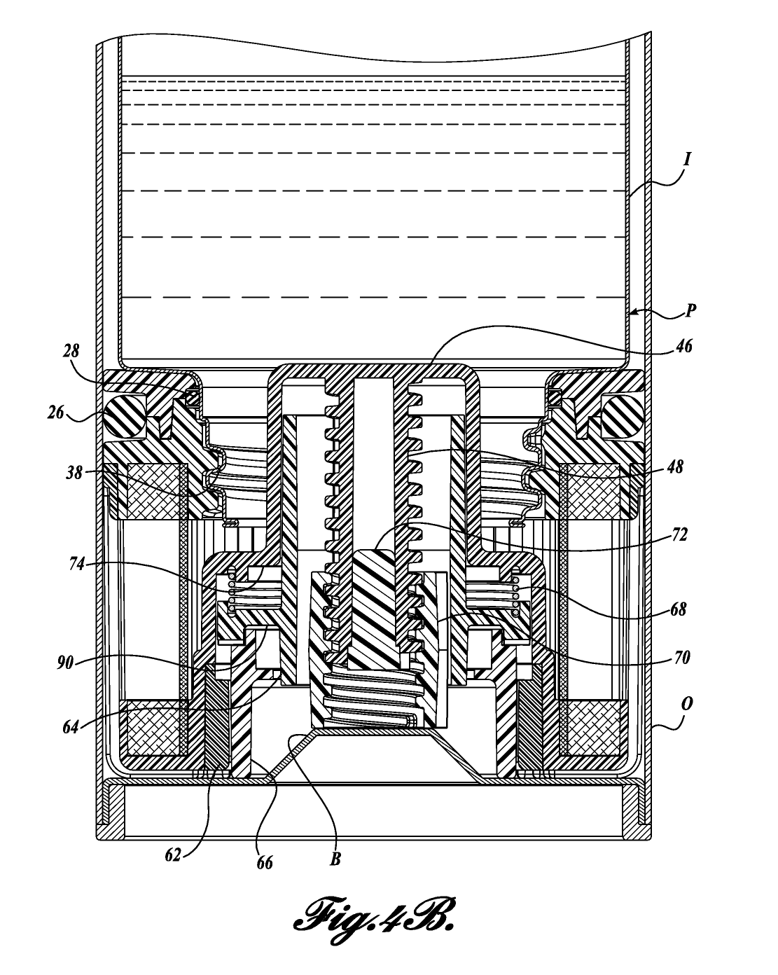

In the illustrated embodiment, the filter housing 22 includes first and second mating portions 30 and 32 for containing the filter media 24. The first portion 30 is an upper retainer portion, and the second portion 32 is a base portion. As can be seen in FIGS. 2 and 3, the second portion 32 includes a plurality of outer holes or slots 34. Therefore, the second portion 32 provides structure to contain the filter media 24, but also allows the flow of liquid into the housing 22 and the filter media 24. The second portion 32 further includes a center protrusion 46 having an inner threaded extension 48, as can be seen in FIG. 3 and will be described in greater detail below. The first portion 30 includes a center hole 36 that allows liquid to pass from holes 34 in the second portion 32 through the filter media 24 into an inner sleeve I (see flow of liquid as indicated by the arrows A2 in FIG. 4A).

As can be seen in FIGS. 4A and 4B, the inner sleeve I is coupled to the filtration assembly 20 of the illustrated embodiment by a threaded connection. Together, the inner sleeve I and the filtration assembly 20 make up the plunging assembly P for the container assembly C. In that regard, the center hole 36 of the first housing portion 30 includes a female threaded portion 38 for receiving a male threaded portion on the inner sleeve I. Second seal 28 creates a seal between the filtration assembly 20 and the inner sleeve I to prevent leakage.

The filter housing is designed and configured to be received within the container assembly C for positive pressure liquid displacement. Seal 26, which nests in a space 42 defined between the first housing portion 30 and an upper retainer 44 (see FIG. 3), is a “floating seal” that forms a seal with the outer container C when subjected to positive pressure to force all liquid in the outer container C to travel through the filtration assembly 20 into the inner sleeve I. In that regard, because the space 42 is sized to be slightly larger than the diameter of the seal 26, the seal 26 is movable between first “up” and second “down” positions (compare FIGS. 5B and 5D).

The first housing portion 30 and upper retainer 44 may be joined by any suitable means including but not limited to interference fit, snap fit, adhesive, sonic welding, spin welding, etc. In the illustrated embodiment, seals 26 and 28 are shown as o-ring type seals; however, other types of seals are also within the scope of the present disclosure.

As can be seen in FIG. 4A, when subjected to positive pressure, liquid travels from the outer container O, through holes 34 in the filter housing 22, through the filter media 24 (see holes 34 and filter media 24 in FIG. 2), and into the inner sleeve I of the container assembly, as indicated by arrows A2.

The filter media 24 is contained with first and second filter potting portions 50 and 52 (see FIG. 2). The potting portions 50 and 52 are used to secure and seal the filter media 24 in place. In that regard, the potting portions 50 and 52 may include a liquid or paste potting that is poured or applied into the wells or groove of the potting portions 50 and 52. In another embodiment, the potting portions 50 and 52 may be adhered by sonic welding, spin welding, or other non-liquid, non-paste techniques.

The filtration assembly 28 can therefore be formed by placing the filter media 24 in the potting portions 50 and 52. The potting portions 50 and 52 are then received in grooves 54 and 56 in the respective first and second housing portions 30 and 32, and may be joined by any suitable means including but not limited to interference fit, snap fit, adhesive, sonic welding, spin welding, etc. The purpose of the potting is to seal the filter media 24 within the filter housing, to prevent seeping of contaminated liquid, and to maintain the filtration assembly 20 as an assembly.

In one embodiment of the present disclosure, the filter media 24 may be a non-woven media filter, for example, including carbon, alumina fibers, silver or any other bacteria, virus, odor or flavor reducing material. The filter media may be capable of filtering, although not limited to, Cryptosporidium, Giardia, viruses, odors, and flavors from liquids. In the illustrated embodiment, the filter media 24 is a single-layer, circular filter. However, it should be appreciate that double filters are also within the scope of the present disclosure. Likewise, it should be appreciated that triple and other multiple filters, as well as other types of filters, including but not limited to activated carbon block, reverse osmosis, granular activated carbon, ion exchange, and others, are also within the scope of the present disclosure.

Use of an exemplary filtration container assembly C will now be described in greater detail with reference to FIGS. 5A-5D. Referring to FIGS. 5A-5D, the outer container O and the inner sleeve I are capable of nesting with one another. In that regard, the filter assembly 20 attaches to the inner sleeve I and seats at the bottom of the inner cavity of the outer container C, with seal 26 forming a seal with the inner wall of the outer container O (see FIG. 5C).

Referring to FIG. 5A, when the inner sleeve I has been removed from the outer container O, the outer container O can be filled with liquid (such as water).

Referring to FIGS. 5B and 5C, as the plunging assembly P (inner sleeve I and filtration assembly 20) is inserted into the outer container C, the filtration assembly 20 filters liquid from the outer container C through the filtration assembly 20 and stores it in the inner sleeve I.

Referring to FIG. 5D, the liquid has been removed from the inner sleeve I, and the plunging assembly P may be removed from the outer container O so that the outer container O can be refilled (see FIG. 5A). As the plunging assembly P is removed from the outer container O, seal 26 of the filtration assembly 20 moves to the “down” position, creating a pathway for air or liquid to release the pressure in the outer container C, as shown by the arrows A1 in FIG. 5D.

Referring now to FIG. 5A, with the plunging assembly P removed from the outer container C, the outer container C can be filled with liquid. Referring now to

FIG. 5B, after the outer container C has been filled with liquid, the plunging assembly P can be reinserted into the outer container C to filter the liquid through the filtration assembly 20 and store it in the inner bore of the inner sleeve I. As can be seen in FIG. 5B, when filtering, seal 26 of the filtration assembly 20 moves to the “up” position, creating a seal between the outer container C and the inner sleeve I and thereby forcing all liquid in the outer container C through the filtration assembly 20 and into the inner bore of the inner sleeve I, as shown by the arrows A2. Referring to FIG. 5C, the inner container I is shown fully inserted in the outer container 22.

According to an aspect of the present disclosure, the filtration assembly 20 may also include a counting assembly 60. The construction and operation of one example of the counting assembly 60 will now be described. Referring to FIGS. 2-4B, the counting assembly 60 generally includes a lower cap 62, a first movable member, for example, shown as a biased advancement device or “clicker” 66, and a second movable member, for example, shown as an orbiter 64, all concentric with and configured to interact with one another. Referring to FIG. 4A, a biasing member 68 (shown as a spring, see FIG. 2) is normally biased against an annular rim 90 of the orbiter 64, such that orbiter 64 and clicker 66 are biased away from an inner shoulder 74 extending from the center protrusion 46 of the second housing portion 32. A traveler 70 and a stop plug 72 are configured to adjoin with the threaded portion 48 of the second housing portion 32. The stop plug 72 in some embodiments aims to prevent the traveler 70 from decoupling from the center protrusion 46 of the second housing portion 32, and falling to the bottom of the filter assembly. As will be described in more detail below, the traveler 70 is configured to co-rotate with the orbiter 64 about threaded portion 48.

Referring to FIG. 4B, compression of the biasing member 68 is shown. In that regard, the filtration assembly 20 is pressed against the bottom B of the outer container O, forcing the orbiter 64 and the clicker 66 upward into the center protrusion 46 of the second housing portion 32. Such upward movement compresses biasing member 68 between the annular rim 90 of the orbiter 64 and the inner shoulder 74 extending from the center protrusion 46 of the second housing portion 32. To assemble the counting assembly 60, the traveler 70 is threaded to the threads of the threaded portion 48 of the second housing portion 32. After the traveler 70 has been threaded, the stop plug 72 can be welded or otherwise affixed to the threaded portion 48 of the second housing portion 32. Then, the biasing member 68, orbiter 64, and clicker 66 are inserted, and the teeth of the lower cap 62 are welded or otherwise affixed to the second housing portion 32.

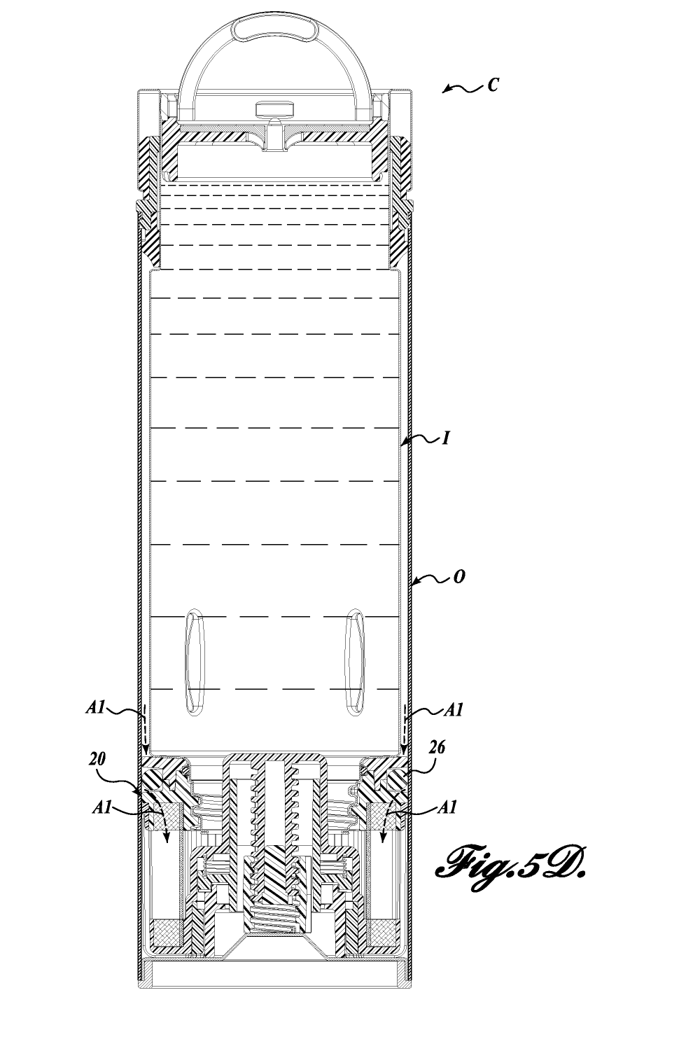

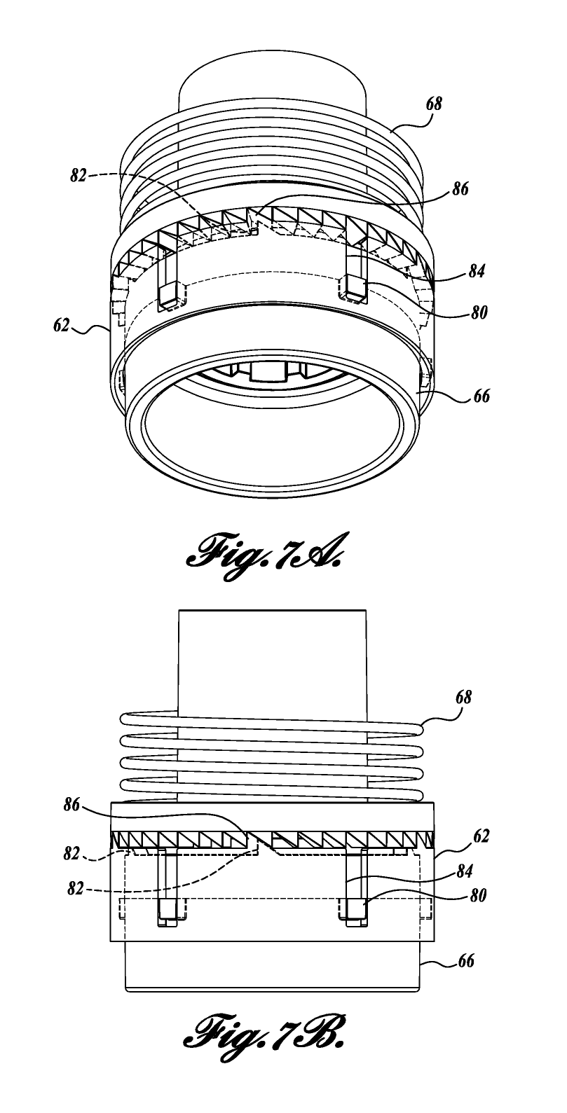

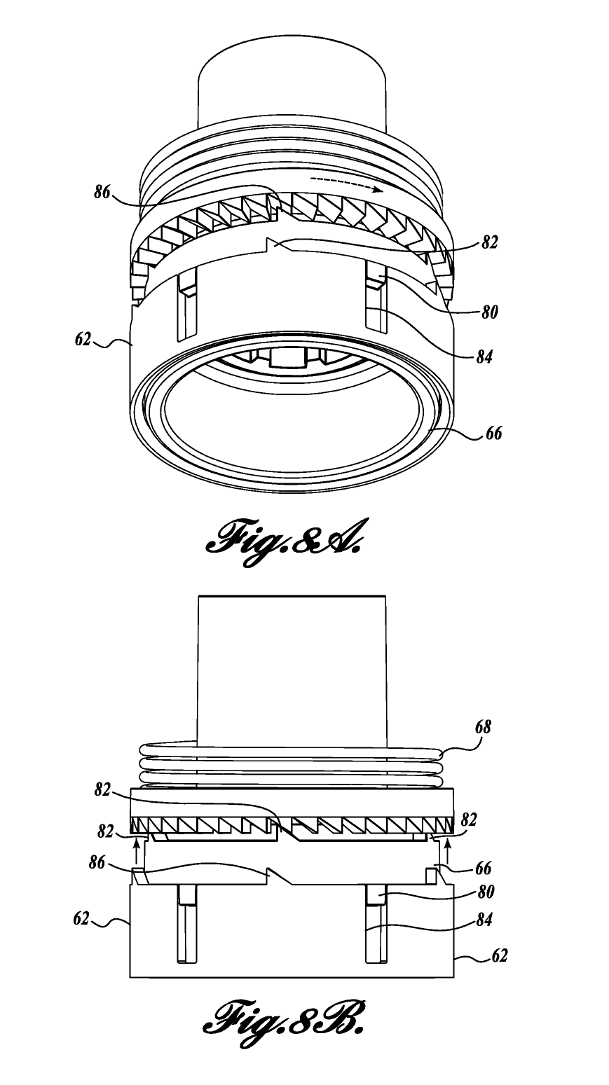

To explain the operation of the counting assembly 60, simplified views of the counting assembly 60 components are provided in FIG. 6A-11B. Referring to FIGS. 6A/B, the clicker 66 is substantially cylindrical part including a plurality of protrusions 80 extending radially outwardly from its outer wall. The clicker 66 further includes a plurality of teeth 82 extending upwardly from a top rim. The clicker 66 can be received in the inner bore of the lower cap 62. In that regard, the lower cap 62 is also a substantially cylindrical part having a plurality of channels 84 along its cylindrical wall for receiving the clicker protrusions 80. The lower cap 62 further includes a plurality of teeth 86 extending upwardly from a top rim (for an improved view of lower cap teeth 86, see FIGS. 8A/B). When aligned with each other, the teeth 82 of the clicker 66 and the teeth 86 of the lower cap 62 are offset by ½ tooth distance (compare position of clicker tooth 82 with lower cap tooth 86 in FIGS. 8A/B).

The orbiter 64 is a substantially cylindrical part having an outer annular rim 90. A plurality of teeth 92 extend from the bottom surface of the annular rim 90 and are configured to align with the teeth 86 of the lower cap 62 and the teeth 82 of the clicker 66. To enable alignment with both sets of lower cap teeth 86 and clicker teeth 82, the orbiter teeth 92 may be sized to be wider than the lower cap teeth 86 and the clicker teeth 82. As a non-limiting example, the orbiter teeth 92 may be as wide as the sum of the widths of the lower cap teeth 86 and the clicker teeth 66.

As seen in FIGS. 6A/B, the protrusions 80 of the clicker 66 are in a first position in the channels 84 of the lower cap 62, such that the clicker 66 extends from the bottom of the lower cap 62. The clicker 66 is in this position relative to the lower cap 62 when the filtration assembly 20 is filtering liquid (e.g., see FIG. 4A).

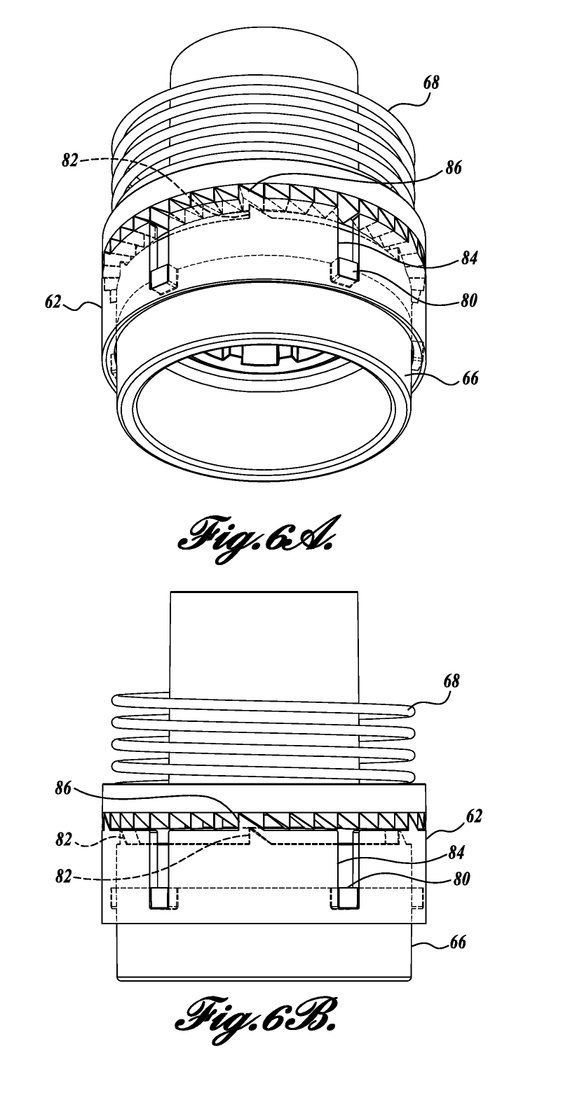

When the plunging assembly P is pushed into the outer container O, and as the filtration assembly 20 impacts the bottom of the outer container C, the clicker 66 begins to be pushed upward, as can be seen in the series of FIGS. 7A/B and 8A/B. In that regard, the teeth 82 of the clicker 66 begin to contact the teeth 92 of the orbiter 64. As the clicker 62 continues to be pushed upward and becomes flush with the bottom of the outer container C, as can be seen in FIG. 8A/B, the teeth 82 of the clicker 62 engage with the teeth 92 of the orbiter 64. Such engagement causes the teeth 82 of the clicker 62 to lift the orbiter 64 away from the lower cap 62, such that the teeth 86 of the lower cap 62 no longer engage the teeth 92 of the orbiter 64.

The biasing force by the compressed biasing member 68 against the orbiter 64 causes the teeth 92 of the orbiter 64 to slide down the ramped teeth 82 of the clicker 66. Because of the offset tooth distance between the teeth 82 of the clicker 66 and the teeth 86 of the lower cap 62, the obiter 64 rotates, advancing V2 tooth distance to the right in the illustrated embodiment (compare positioning of orbiter 64 in FIGS. 8A/B and 9A/B).

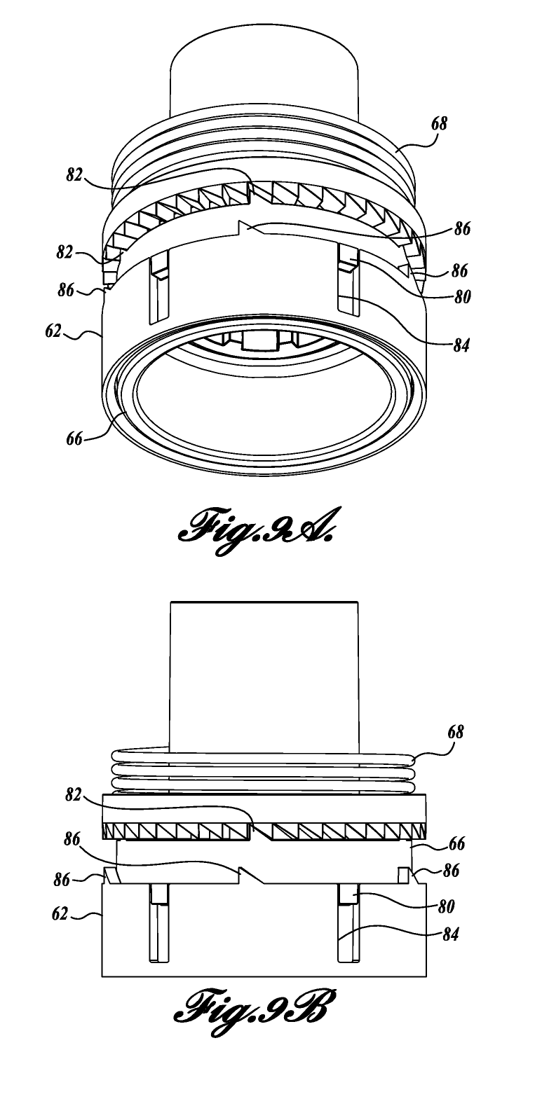

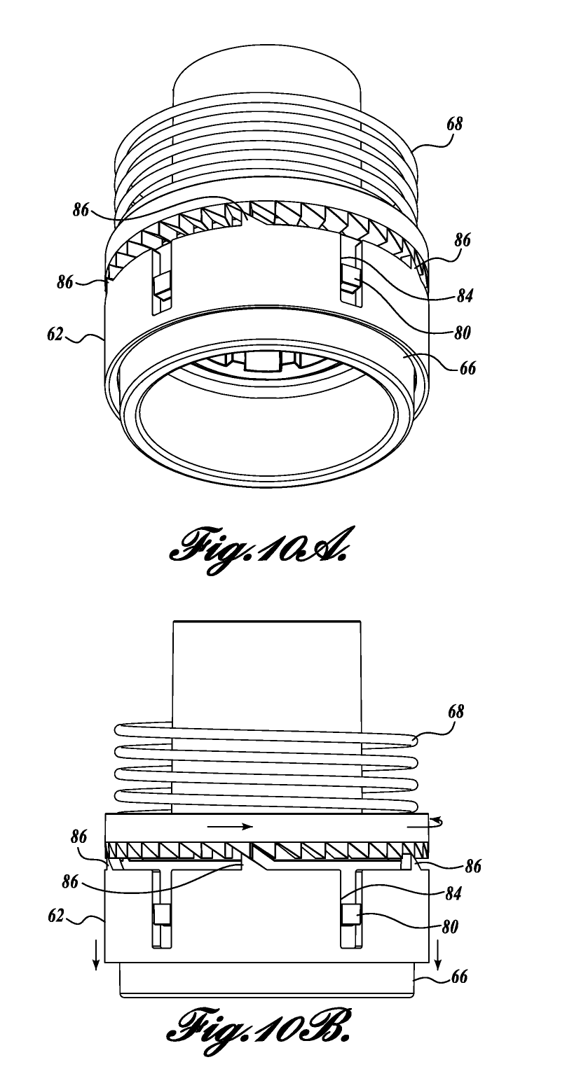

Referring to FIGS. 10A/B and 11A/B, as the plunging assembly P is removed from the outer container C, the clicker 66 is biased downward by the force of the biasing member 68 until the obiter 64 makes contact with the teeth 86 of the lower cap 62. Again, because of the offset tooth distance between the teeth 82 of the clicker 66 and the teeth 86 of the lower cap 62, the obiter 64 rotates, advancing V2 tooth distance to the right in the illustrated embodiment (compare positioning of orbiter 64 in FIGS. 10A/B and FIGS. 11A/B).

Therefore, the clicker 66 in the illustrated embodiment is biased in a first position and configured for translational movement between a first position and a second position relative to the outer container O (compare FIGS. 4A and 4B). The orbiter 64 is configured for rotational movement to sequentially move a fixed segment of a path of travel with respect to the filter housing 22 each time the clicker 66 moves from the first position (see FIG. 4A) to the second position (see FIG. 4B) and each time the clicker 66 moves from the second position (see FIG. 4B) to the first position (see FIG. 4A). In a full cycle of inserting the plunging assembly P into the outer container C and removing the plunging assembly P from the outer container C, the counting assembly 60 advances one tooth distance. In the illustrated embodiment, the counting assembly 60 includes forty teeth in a full rotation, although other numbers of teeth may be employed, such as twenty, thirty, etc.

After completing a number of advances, such as forty in the illustrated embodiment, the traveler 70 completes at least a full rotation and advances down the threaded portion 48 of the center protrusion 46 of the second housing portion 32, for example, down one thread. In some embodiments, when the traveler 70 is in its advanced state, the traveler may interface with a surface of the outer container C, thereby preventing the inner sleeve I from fully nesting with the outer container C. This interface may assist in disabling the filtration assembly 20 by preventing further use of the filtration assembly 20. It will be appreciated that the counting assembly 60 can be configured such that the traveler 70 attains such as position after completing less than a full rotation. In some embodiments, a visual aid, such as a red band or the like, can be provided around the exposed portion of the plunging assembly, which is visual above the outer container C when the filter is considered exhausted. This visual aid can provide an additional notification to the user that the filter is exhausted.

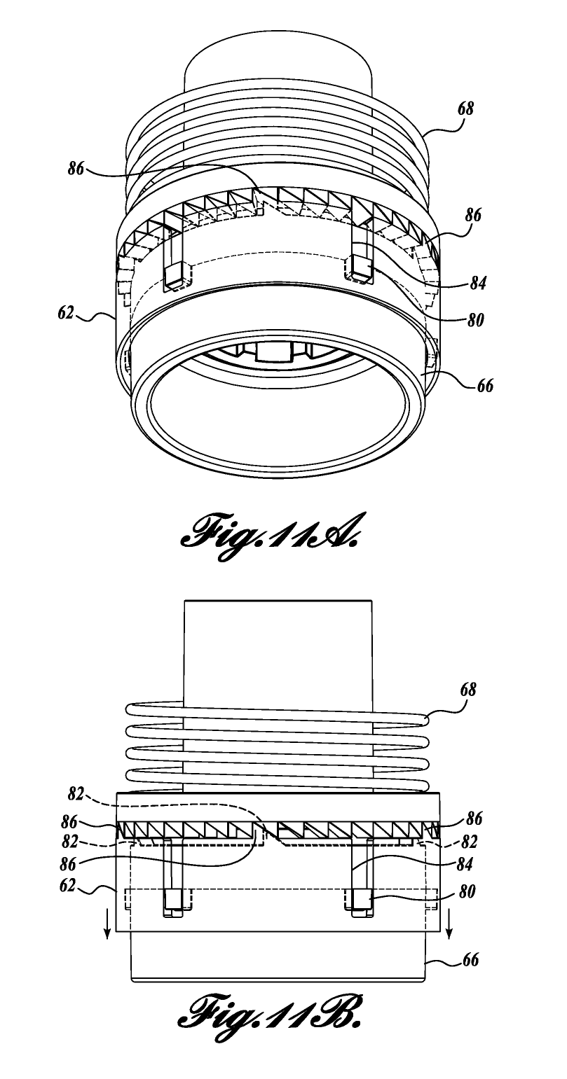

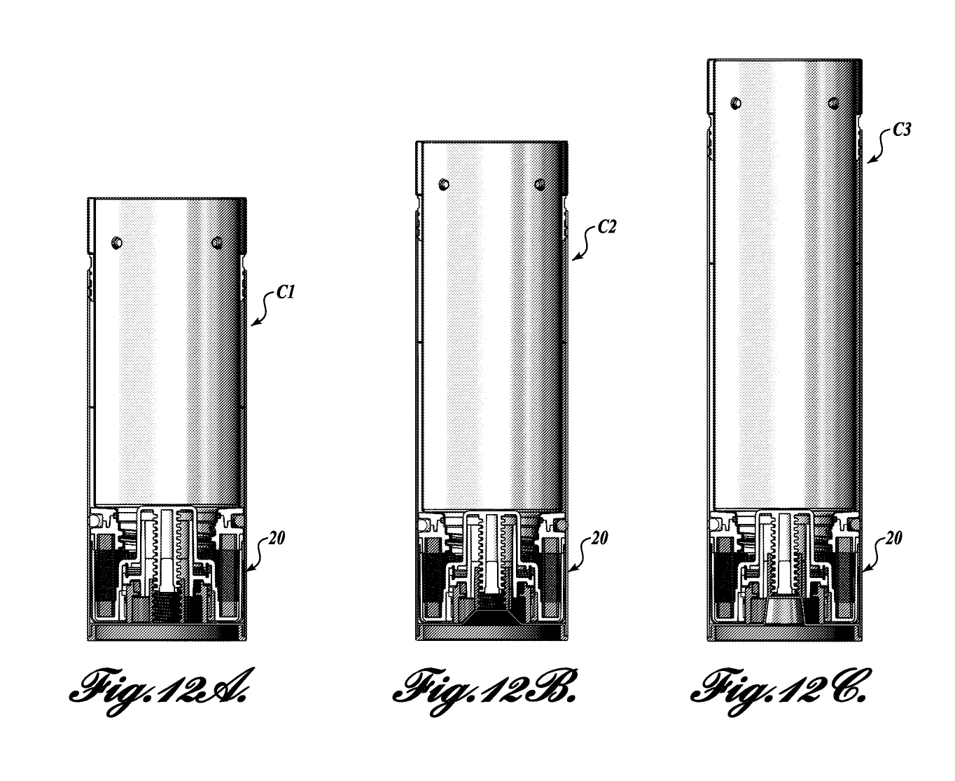

It will be appreciated that at least a portion of the bottom of the outer container C1, C2, and C3 can be designed at different heights to allow for a different number of cycles of filtering fluid to exhaust the filter, as best shown in respective FIGS. 12A, 12B, and 12C. In that regard, either the associated inner sleeve I or the cup of the container assembler C can be designed for holding a predetermined volume of fluid. Likewise, the height at which the bottom of the outer container C is positioned can be designed to correspond with an aggregate amount of filtered fluid (e.g., volume of inner sleeve or cup multiplied by the number of times the inner sleeve is inserted into the container C) that will attain a suggested exhaustion condition of the filter. For instance, the illustrated embodiment of FIGS. 1-5D depicts a bottom of the outer container C2 (see FIG. 12B) designed for a cup of medium volume.

However, if the cup where larger in volume, the filter would have to filter more fluid with each plunging cycle. Therefore, the number of cycles or times that the filter can be used before attaining the suggested exhaustion condition of the filter would be fewer. To account for this difference, the bottom of the outer container C3 would be located at a higher position for this larger cup, thereby impacting the traveler after fewer completed cycles. Conversely, if the cup were smaller, the bottom of the outer container C1 would be located at a lower position. This would allow the traveler more distance to travel, hence more uses, before the suggested exhausted condition is attained. Referring to FIG. 12A, 12B, and 12C, three different filtration assembly 20 configurations are provided for three different containers C1, C2, and C3 having increasing volumetric capacity.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A filtration assembly, comprising:
(a) a housing having a first end configured to interface with an outer container and having a second end configured to interface with an inner sleeve, wherein the housing includes a plurality of apertures configured to pass a liquid therethrough; and
(b) a counting device carried by the housing, wherein the counting device is configured to indicate to a user that an associated filter is exhausted.

2. The filtration assembly of claim 1, wherein the liquid includes water.

3. The filtration assembly of claim 1, wherein the first end of the housing is configured to interface with an inner cavity of the outer container to provide positive pressure liquid displacement.

4. The filtration assembly of claim 3, wherein the inner cavity of the outer container and the inner sleeve are concentric with one another.

5. The filtration assembly of claim 3, further comprising a filter supported by the housing and disposed in liquid communication with the plurality of apertures and the inner sleeve.

6. The filtration assembly of claim 5, wherein the filter is exhausted after a predetermined volume of liquid passes through the filter.

7. The filtration assembly of claim 5, wherein the filter is selected from the group consisting of screens, sieve filters, granular-activated carbon filters, metallic alloy filters, microporous ceramic filters, a carbon block resin filters, electrostatic nanofiber filters, reverse osmosis filters, ion exchange filters, UV light filters, hollow fiber membrane filters, and ultra-filtration membrane filters.

8. The filtration assembly of claim 1, wherein the indication to a user that an associated filter is exhausted is dependent on volume of filtered liquid.

9. The filtration assembly of claim 3, wherein the counting device includes
a first movable member positioned to interface with the outer container when the housing moves within the inner cavity of the outer container a selected amount; and
a second movable member associated with the first movable member and configured to conditionally move along a path of travel having predetermined total distance, wherein the second movable member sequentially moves a fixed segment of the path of travel with respect to the housing each time the housing moves within the inner cavity of the outer container the predetermined amount.

10. The filtration assembly of claim 9, wherein the counting device indicates to a user that an associated filter is exhausted when the second movable member has moved along the path of travel a distance substantially equal to the predetermined total distance.

11. The filtration assembly of claim 9, wherein the first movable member is biased in a first position, and configured for translational movement between the first position and a second position relative to the outer container.

12. The filtration assembly of claim 11, wherein the second movable member is configured for rotational movement to sequentially move a fixed segment of the path of travel with respect to the housing each time the first movable member moves from the first position to the second position.

13. The filtration assembly of claim 12, wherein the second movable member is configured for rotational movement to sequentially move a fixed segment of the path of travel with respect to the housing each time the first movable member moves from the second position to the first position.

14. A container assembly, comprising;
an outer container having an open ended cavity configured to hold a quantity of liquid;
an inner sleeve configured to slide within the open ended cavity; and
a filtration assembly including:
a housing having a first end configured to interface with the outer container and having a second end configured to interface with the inner sleeve, wherein the housing includes a plurality of apertures configured to pass a liquid between the outer container and the inner sleeve; and
a counting device carried by the housing, wherein the counting device is configured to indicate to a user that an associated filter is exhausted.

15. The container assembly of claim 14, wherein the counting device includes
a first movable member positioned to interface with the outer container when the housing moves within the inner cavity of the outer container a selected amount; and
a second movable member associated with the first movable member and configured to conditionally move along a path of travel having predetermined total distance, wherein the second movable member sequentially moves a fixed segment of the path of travel with respect to the housing each time the housing moves within the inner cavity of the outer container the predetermined amount.

16. The container assembly of claim 15, wherein the counting device indicates to a user that an associated filter is exhausted when the second movable member has moved along the path of travel a distance substantially equal to the predetermined total distance.

17. The container assembly of claim 16, wherein the second movable member contacts a portion of the outer container when moved along the path of travel a distance substantially equal to the predetermined total distance.
